(19) United States
(12) Patent Application Publication
(10) Pub. No.: US 2009/0268377 A1
(43) Pub. Date: Oct. 29, 2009

(54) ELECTROLYTE SOLUTION AND SUPER CAPACITOR INCLUDING THE SAME

(75) Inventors: Jae-Hoon Choi, Seoul (KR); Yu-Mi Chang, Gyeonggi-do (KR)

Correspondence Address: BIRCH STEWART KOLASCH & BIRCH, PO BOX 747, FALLS CHURCH, VA, 22040-0747, US

(73) Assignee: SK CHEMICALS CO., LTD

(21) Appl. No.: 12/439,443

(22) PCT Filed: Aug. 29, 2007
(86) PCT No.: PCT/KR07/04147

§ 371 Date: Feb. 27, 2009

(30) Foreign Application Priority Data
Aug. 31, 2006 (KR) 10-2006-0083444

(51) Int. Cl. H01G 9/155; H01G 9/022

(52) U.S. Cl. 361/502; 252/62.2

(57) ABSTRACT

An electrolyte solution and a super capacitor including the same, which has superior voltage stability, a high operation voltage and a high energy density, are disclosed. The electrolyte solution includes: a C₃-C₄ alkyl-substituted ammonium based electrolytic salt; and a non-aqueous solvent. Preferably, the C₃-C₄ alkyl-substituted ammonium based electrolytic salt includes a cation selected from the quaternary ammonium salt group consisting of tetrapropyl ammonium, tetrabutyl ammonium, and the mixture thereof, and an anion selected from the group consisting of tetrafluoroborate (BF₄⁻), hexafluorophosphate (PF₆⁻), perchlorate (ClO₄⁻), hexafluoroarsenate (AsF₆⁻), bis(trifluoromethylsulfonyl)imide ((CF₃ SO₂)₂N⁻), trifluoromethylsulfonate (SO₃ CF₃⁻), and the mixtures thereof.

### TECHNICAL FIELD

This invention relates to an electrolyte solution for a capacitor, and more particularly, to an electrolyte solution and a super capacitor including the same, which has superior voltage stability, a high operation voltage and a high energy density.

### BACKGROUND ART

A super capacitor is an energy storage device having the features of electrolytic condensers and secondary batteries. The features of the super capacitor include a rapid charging and discharging, a high efficiency, a wide operation temperature and a semi-permanent life span, and an electric double-layer capacitor is a representative example of the super capacitor. In general, an electrochemical cell, such as the super capacitor, the electric double-layer capacitor, the secondary battery, and so on, includes two electrodes (anode and cathode) and an electrolyte, and has the greater energy storage density as the maximum operation voltage thereof increases. For example, in a capacitor, the stored energy can be calculated by the equation, E=½·C·V² (E: Energy, C: Capacitance, V: Voltage), which means that the maximum operation voltage is very important in the energy storage.

Meanwhile, it is well known that the maximum operation voltage can be varied according to the kinds of an electrolytic salt and a solvent used in the super capacitor. Therefore, the conventional aqueous electrolyte has been replaced with a non-aqueous electrolyte using an organic solvent, and especially, a carbonate based solvent has been widely used due to its superior voltage stability. For example, an electrolyte including a methyl- or ethyl-substituted ammonium based electrolytic salt (for example, tetra-ethyl ammonium tetra-fluoroborate or tri-ethyl methyl ammonium tetra-fluoroborate) and an organic solvent (for example, propylene carbonate or acetonitrile) has been developed. However, the maximum operation voltage of the capacitor using the electrolyte is not satisfactory. In order to solve this problem, a lithium based electrolytic salt (for example, lithium hexa-fluorophosphate or lithium tetra-fluoroborate), which is conventionally used for a secondary battery and has superior voltage stability, is used with the conventional electrolytic salt. However, the electrical conductivity of the electrolyte remarkably decreases, and thus the properties of the super capacitor are deteriorated.

### DISCLOSURE OF INVENTION

### Technical Problem

It is an object of the present invention to provide an electrolyte solution having superior voltage stability and electrical conductivity.

It is other object of the present invention to provide a super capacitor or an electric double-layer capacitor having a high operation voltage and a high energy storage density.

### Technical Solution

In order to achieve these objects, the present invention provides an electrolyte solution comprising: a C₃-C₄ alkyl-substituted ammonium based electrolytic salt; and a non-aqueous solvent. Preferably, the C₃-C₄ alkyl-substituted ammonium based electrolytic salt includes a cation selected from the quaternary ammonium salt group consisting of tetrapropyl ammonium, tetrabutyl ammonium, and the mixture thereof, and an anion selected from the group consisting of tetrafluoroborate (BF₄⁻), hexafluorophosphate (PF₆⁻), perchlorate (ClO₄⁻), hexafluoroarsenate (AsF₆⁻), bis(trifluoromethylsulfonyl)imide ((CF₃SO₂)₂N⁻), trifluoromethylsulfonate (SO₃CF₃⁻), and the mixtures thereof. Also, the present invention provides a super capacitor including an electrolyte solution which comprises a C₃-C₄ alkyl-substituted ammonium based electrolytic salt and a non-aqueous solvent.

### MODE FOR THE INVENTION

A more complete appreciation of the invention, and many of the attendant advantages thereof, will be better appreciated by reference to the following detailed description.

The electrolyte solution according to the present invention includes a C₃-C₄ alkyl (namely, alkyl group of 3 to 4 carbon atoms)-substituted ammonium based electrolytic salt and a non-aqueous solvent. Preferably, the cation of the C₃-C₄ alkyl-substituted ammonium based electrolytic salt includes tetrapropyl ammonium, tetrabutyl ammonium, the mixture thereof, and so on. The anion which is combined with the cation of the electrolytic salt can be a conventional anion of an electrolytic salt for a conventional lithium secondary battery. Preferable examples of the anion include tetrafluoroborate (BF₄⁻), hexafluorophosphate (PF₆⁻), perchlorate (ClO₄⁻), hexafluoroarsenate (AsF₆⁻), bis(trifluoromethylsulfonyl)imide ((CF₃SO₂)₂N⁻), trifluoromethyl-sulfonate (SO₃CF₃⁻), and the mixtures thereof. If the number of carbon atoms of the alkyl group substituted to the ammonium salt is less than 3 (namely, when the alkyl group is methyl or ethyl.), the maximum operation voltage of the capacitor may decrease. If the number of carbon atoms of the alkyl group substituted to the ammonium salt is more than 4 (namely, when the alkyl group is pentyl, hexyl, or so on), the electric conductivity of the electrolyte may decrease, and the resistance of the capacitor may increase. More preferably, the C₃-C₄ alkyl-substituted ammonium based electrolytic salt is tetrabutyl ammonium tetrafluoroborate or tetrabutyl ammonium hexafluorophosphate. The C₃-C₄ alkyl-substituted ammonium based electrolytic salt of the present invention can be used with the conventional methyl- or ethyl-substituted ammonium based electrolyte salt (for example, tetra-ethyl ammonium tetrafluoroborate or tri-ethyl methyl ammonium tetrafluoroborate).

The concentration of the C₃-C₄ alkyl-substituted ammonium based electrolytic salt is preferably 0.5 to 2.0M, and more preferably 0.8 to 1.5M. If the concentration of the electrolytic salt is less than 0.5M, the electric conductivity of the electrolyte may decrease, and thus resistance of the capacitor may increase. If the concentration of the electrolytic salt is more than 2.0M, the electrolytic salt may be not completely dissolved, the electric conductivity of the electrolyte may decrease, or the electrolytic salt may be partially precipitated at a low temperature.

The C₃-C₄ alkyl-substituted ammonium based electrolytic salt can be prepared by, but not limited to, the following method. First, tetrabutyl ammonium bromide is dissolved with acetone, and sodium tetrafluoroborate(NaBF₄) is added thereto, and the mixture is stirred for 24 hours at room temperature. After completion of the stirring, the reaction solution is filtered to remove produced salt and the filtered solution is distilled under a reduced pressure to obtain a product. Then the product is dissolved with distilled water. Next, the aqueous solution containing the product is extracted with chloroform for several times and distilled under a reduced pressure to obtain tetrabutyl ammonium tetrafluoroborate in white solid state.

Examples of the non-aqueous solvent which dissolves the ammonium based electrolytic salt according to the present invention include propylene carbonate(PC), acetonitrile(AN), tetrahydrofuran(THF), gamma-butyrolactone(GBL), ethylene carbonate(EC), ethylmethyl carbonate(EMC), dimethyl carbonate(DMC), diethyl carbonate(DEC), the mixtures thereof, and so on. More preferably, the non-aqueous solvent can be a mixture of propylene carbonate(PC) or ethylene carbonate(EC) and a linear carbonate, such as ethylmethyl carbonate(EMC), dimethyl carbonate(DMC), diethyl carbonate(DEC), and so on. In this case, the amount of the linear carbonate which is selected from the group consisting of ethylmethyl carbonate(EMC), dimethyl carbonate(DMC), diethyl carbonate(DEC) and the mixtures thereof is preferably 5 to 80 weight % with respect to the total non-aqueous solvent. If the linear carbonate solvent is used with propylene carbonate(PC), the amount of the linear carbonate is preferably 5 to 40 weight % with respect to the total non-aqueous solvent. If the linear carbonate solvent is used with ethylene carbonate(EC), the amount of the linear carbonate is preferably 40 to 80 weight % with respect to the total non-aqueous solvent. If the amount of the linear carbonate is within the above-mentioned ranges, the viscosity of the electrolyte can be reduced, and the electric conductivity thereof can be improved by 10 to 30%.

The present invention further provides a super capacitor using the electrolyte solution, in which the C₃-C₄ alkyl-substituted ammonium based electrolytic salt and the non-aqueous solvent are mixed. The conventional electric double-layer capacitor can be used as the super capacitor of the present invention. For example, the super capacitor comprises: electrodes which includes a cathode and an anode; a separator for electrically isolating the cathode and the anode; and an electrolyte solution located between the cathode and the anode so as to form electrical double-layers on the surfaces of the cathode and the anode when a voltage is applied between the cathode and the anode.

Hereinafter, the preferable examples of the present invention and comparative examples are provided for better understanding of the present invention. Following examples are to illustrate the present invention, and the present invention is not limited by the following examples.

### EXAMPLE 1

### Preparation of Electrolyte Solution

69.2 g of tetrabutyl ammonium bromide was dissolved with 750 ml of acetone, 30.7 g of sodium tetrafluoroborate(NaBF₄) was added thereto, and the mixture was stirred for 24 hours at room temperature. After completion of the stirring, the reaction solution was filtered to remove produced salt and the filtered solution was distilled under a reduced pressure to obtain a product. Then the obtained product was dissolved with distilled water. Next, the aqueous solution containing the product was extracted with chloroform for 3 times and distilled under a reduced pressure to obtain 45.6 g of tetrabutyl ammonium tetrafluoroborate (TBABF₄) in white solid state. Next, the obtained tetrabutyl ammonium tetrafluoroborate was dissolved with propylene carbonate(PC) to produce 1M electrolyte solution. The electric conductivity of the produced electrolyte solution was measured at various temperature with a conductivity meter (thermo, Orion 136S), and the results are set forth in Table 1.

### EXAMPLE 2

### Preparation of Electrolyte Solution

Tetrabutyl ammonium tetrafluoroborate(TBABF₄) prepared in Example 1 was dissolved with a solvent mixture which was formed by mixing propylene carbonate(PC) and ethylmethyl carbonate(EMC) of linear carbonate by the volume ratio of 85:15, to produce 1M electrolyte solution. The electric conductivity of the produced electrolyte solution was measured at various temperature with a conductivity meter (thermo, Orion 136S), and the results are set forth in Table 1.

### EXAMPLE 3

### Preparation of Electrolyte Solution

Tetrabutyl ammonium tetrafluoroborate(TBABF₄) prepared in Example 1 was dissolved with a solvent mixture which was formed by mixing propylene carbonate(PC) and dimethyl carbonate(DMC) of linear carbonate by the volume ratio of 85:15, to produce 1M electrolyte solution. The electric conductivity of the produced electrolyte solution was measured at various temperature with a conductivity meter (thermo, Orion 136S), and the results are set forth in Table 1.

### EXAMPLE 4

### Preparation of Electrolyte Solution

Tetrabutyl ammonium tetrafluoroborate(TBABF₄) prepared in Example 1 was dissolved with a solvent mixture which was formed by mixing propylene carbonate(PC) and diethyl carbonate(DEC) of linear carbonate by the volume ratio of 85:15, to produce 1M electrolyte solution. The electric conductivity of the produced electrolyte solution was measured at various temperature with a conductivity meter (thermo, Orion 136S), and the results are set forth in Table 1.

### EXAMPLE 5

### Preparation of Electrolyte Solution

66.6 g of tetrapropyl ammonium bromide was dissolved with 750 ml of acetone, 30.7 g of sodium tetrafluoroborate(NaBF₄) was added thereto, and the mixture was stirred for 24 hours at room temperature. After completion of the stirring, the reaction solution was filtered to remove produced salt and the filtered solution was distilled under a reduced pressure to obtain a product. Then the obtained product was dissolved with distilled water. Next, the aqueous solution containing the product was extracted with chloroform for 3 times and distilled under a reduced pressure to obtain 43.7 g of tetrapropyl ammonium tetrafluoroborate (TBABF₄) in white solid state. Next, the obtained tetrapropyl ammonium tetrafluoroborate was dissolved with propylene carbonate(PC) to produce 1M electrolyte solution. The electric conductivity of the produced electrolyte solution was measured at various temperature with a conductivity meter (thermo, Orion 136S), and the results are set forth in Table 1.

### COMPARATIVE EXAMPLE 1

### Preparation of Electrolyte Solution

65.1 g of tetraethyl ammonium bromide was dissolved with 750 ml of acetone, 30.7 g of sodium tetrafluoroborate(NaBF₄) was added thereto, and the mixture was stirred for 24 hours at room temperature. After completion of the stirring, the reaction solution was filtered to remove produced salt and the filtered solution was distilled under a reduced pressure to obtain a product. Then the obtained product was dissolved with distilled water. Next, the aqueous solution containing the product was extracted with chloroform for 3 times and distilled under a reduced pressure to obtain 42.5 g of tetraethyl ammonium tetrafluoroborate (TEABF₄) in white solid state. Next, the obtained tetraethyl ammonium tetrafluoroborate was dissolved with propylene carbonate(PC) to produce 1M electrolyte solution. The electric conductivity of the produced electrolyte solution was measured at various temperature with a conductivity meter (thermo, Orion 136S), and the results are set forth in Table 1.

### EXAMPLE 6

### Preparation of Electrolyte Solution

Tetrabutyl ammonium tetrafluoroborate prepared in Example 1 was dissolved with propylene carbonate(PC) to produce 0.5M solution, and tetraethyl ammonium tetrafluoroborate prepared in Comparative Example 1 was also dissolved with the solution to produce 0.5M solution. The electric conductivity of the produced electrolyte solution was measured at 25° C. with a conductivity meter (thermo, Orion 136S), and the results is set forth in Table 1.

### EXAMPLE 7

### Preparation of Electrolyte Solution

Except for using a solvent mixture which was formed by mixing propylene carbonate(PC) and dimethyl carbonate(DMC) of linear carbonate by the volume ratio of 85:15 instead of propylene carbonate(PC), an electrolyte solution containing 0.5M of tetrabutyl ammonium tetrafluoroborate electrolytic salt and 0.5M of tetraethyl ammonium tetrafluoroborate electrolytic salt was prepared in the same manner as described in Example 6. The electric conductivity of the produced electrolyte solution was measured at 25° C. with a conductivity meter (thermo, Orion 136S), and the results is set forth in Table 1.

### EXAMPLES 8˜14 AND COMPARATIVE EXAMPLE 2

### Preparation of Electric Double-Layer Capacitor

A slurry was prepared by mixing activated carbon (BP20, Kuraray Chemical), a binder (PVDF: Polyvinylidene fluoride, Atofina) and a conducting material (Super P Black, MMM Carbon) by the weight ratio of 90:7:3. The prepared slurry was coated and roll-pressed on an aluminum (Al) foil to produce a charcoal electrode for a cathode and an anode. The produced electrode was cut by 2 cm 3 cm size. The cathode, a separator (Celgard, PP) and the anode were sequentially stacked and inserted into a pouch. Then, the electrolyte solutions prepared in Examples 1 to 7 and Comparative Example 1 were injected into the pouch to produce pouch-type capacitors. The maximum operation voltage of the produced capacitor (Examples 8 to 14) was measured with an electrochemical analyzer (CH Instrument, 608B), and the voltage stability of the capacitor was confirmed by 10 mV/sec scanning, and the results are set forth in Table 1.

TABLE 1

| | Maximum operation | Conductivity of electrolyte (mS/cm) | | |
|---|---|---|---|---|
| | voltage (V) | −20° C. | −10° C. | 25° C. |
| Example 1 | 3.4 (Example 8) | 2.3 | 3.2 | 7.5 |
| Example 2 | 3.4 (Example 9) | 2.7 | 4.2 | 9.3 |
| Example 3 | 3.4 (Example 10) | 3.2 | 3.7 | 10.1 |
| Example 4 | 3.4 (Example 11) | 4.6 | 5.3 | 8.8 |
| Example 5 | 3.0 (Example 12) | 3.2 | 4.5 | 10.5 |
| Example 6 | 3.2 (Example 13) | — | — | 11.1 |
| Example 7 | 3.2 (Example 14) | — | — | 14.3 |
| Comparative | 2.8 (Comparative | 4.1 | 5.8 | 13.6 |
| Example 1 | Example 2) | | | |

From Table 1, the electrolyte solution of Comparative Example 1 (conventional tetraethyl ammonium tetrafluoroborate salt in propylene carbonate) has a good electric conductivity, but the maximum operation voltage of the capacitor (Comparative Example 2) containing the electrolyte solution is very low (2.8V). On the other hand, the capacitor (Example 12) containing the electrolyte solution of Example 5 (tetrapropyl ammonium tetrafluoroborate salt in propylene carbonate) has the maximum operation voltage of 3.0V while the electric conductivity of the electrolyte solution decreases compared with the electrolyte solution of Comparative Example 1. The electrolyte solution of Example 1 (tetrabutyl ammonium tetrafluoroborate salt in propylene carbonate) has improved voltage stability and the capacitor (Example 8) containing the electrolyte solution has the maximum operation voltage of 3.4V. However, the electric conductivity of the electrolyte solution of Example 1 decreases compared with the electrolyte solution of Comparative Example 1.

When the solvent mixture including propylene carbonate and the linear carbonate (for example, EMC, DMC or DEC) of low viscosity is used (Examples 2, 3 and 4) instead of propylene carbonate (Example 1), the operation voltage of capacitors (Examples 9, 10 and 11) containing the respective electrolyte solution is maintained to 3.4 V. In addition, the electric conductivity of the electrolyte solution (Examples 2, 3 and 4) is similar to the conventional value. Specifically, the electric conductivity at low temperature (−20° C., −10° C.) which is an important feature of an electrolyte solution in a practical industrial use is similar to the conventional value.

When the mixture of tetrabutyl ammonium tetrafluoroborate (TBABF₄) salt and tetraethyl ammonium tetrafluoroborate (TEABF₄) salt are used (Example 6), the voltage stability of the electrolyte solution is improved, but the electric conductivity thereof decreases compared with the electrolyte solution of Comparative Example 1. Therefore, the electrolyte solution of Example 6 is advantageous in the voltage stability. When the linear carbonate(DMC) of low viscosity is used with propylene carbonate (Example 7), the electric conductivity of the electrolyte solution increases (14.3 mS/cm at 25° C.) compared with that of Example 6 (11.1 mS/cm at 25° C.) and Comparative Example 1 (13.6 mS/cm at 25° C.)

Accordingly, the physical properties of the capacitor can be controlled by changing the kinds and amounts of the electrolytic salt and the non-aqueous solvent of the electrolyte solution of the present invention. For example, if the amount of tetrabutyl ammonium tetrafluoroborate(TBABF₄) salt increases, a high energy density capacitor having a good voltage property can be prepared. Thus, by controlling the amount of tetrabutyl ammonium tetrafluoroborate(TBABF₄) salt and the amount of the linear carbonate, a high-output capacitor having a constant voltage stability and the minimized electric conductivity drop can be prepared.

As described above, the electrolyte solution according to the present invention has superior voltage stability and electric conductivity. The super capacitor or the electric double-layer capacitor containing the electrolyte solution has the high operation voltage and high energy storage density.

This application claims the priority benefit of Korean Patent Application No. 10-2006-0083444 filed on Aug. 31, 2006. All disclosure of the Korean Patent application is incorporated herein by reference.

1. An electrolyte solution, comprising:
a C₃-C₄ alkyl-substituted ammonium based electrolytic salt; and
a non-aqueous solvent.

2. The electrolyte solution of claim 1, wherein the C₃-C₄ alkyl-substituted ammonium based electrolytic salt includes a cation selected from the group consisting of tetrapropyl ammonium, tetrabutyl ammonium, and the mixture thereof, and an anion selected from the group consisting of tetrafluoroborate (BF₄⁻), hexafluorophosphate (PF₆⁻), perchlorate (ClO₄⁻), hexafluoroarsenate (AsF₆⁻), bis(trifluoromethylsulfonyl)imide ((CF₃SO₂)₂N⁻), trifluoromethylsulfonate (SO₃CF₃⁻), and the mixtures thereof.

3. The electrolyte solution of claim 1, wherein the C₃-C₄ alkyl-substituted ammonium based electrolytic salt is tetrabutyl ammonium tetrafluoroborate or tetrabutyl ammonium hexafluorophosphate.

4. The electrolyte solution of claim 1, wherein the concentration of the C₃-C₄ alkyl-substituted ammonium based electrolytic salt is 0.5 to 2.0M.

5. The electrolyte solution of claim 1, wherein the non-aqueous solvent is selected from the group consisting of propylene carbonate(PC), acetonitrile(AN), tetrahydrofuran(THF), gamma-butyrolactone(GBL), ethylene carbonate(EC), ethylmethyl carbonate(EMC), dimethyl carbonate(DMC), diethyl carbonate(DEC), and the mixtures thereof.

6. A super capacitor including an electrolyte solution, wherein the electrolyte solution comprises: a C₃-C₄ alkyl-substituted ammonium based electrolytic salt; and a non-aqueous solvent.
